(19) United States
(12) Patent Application Publication
(10) Pub. No.: US 2011/0033584 A1
(43) Pub. Date: Feb. 10, 2011

(54) Method and system for dielectric heating and cooking

(75) Inventors: Alexander Bilchinsky, (US); Eran Ben-Shmuel, (US); Eyal Torres, Savyon (IL)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: RF Dynamics Ltd.

(21) Appl. No.: 12/805,505

(22) Filed: Aug. 3, 2010

Related U.S. Application Data
(60) Provisional application No. 61/230,799, filed on Aug. 3, 2009.

(51) Int. Cl. A23L 1/31; A23L 1/315; A23L 1/33; B65B 25/06; A23L 1/01; A23L 1/325

(52) U.S. Cl. 426/129; 426/641; 426/645; 426/644; 426/643; 426/232

(57) ABSTRACT

A method of heating an object using a dielectric heating. The method comprises positioning an object in a cavity of a dielectric heating oven, allowing a user to allocate an amount of energy to dissipate in the object during a temperature elevation of the object, and elevating the temperature of the object by using the dielectric heating oven according to the amount of energy.

### RELATIONSHIP TO EXISTING APPLICATIONS

The present application incorporates by reference the content of International Patent Application Number PCT/IL2007/000235, published on Aug. 30, 2007, International Patent Application Number PCT/IL2007/001073 published on Aug. 28, 2008, International Patent Application Number PCT/IL2007/000236 published on Aug. 30, 2007, and International Patent Application Number PCT/IL2007/000864, published on Jan. 17, 2008.

### FIELD AND BACKGROUND OF THE INVENTION

The present invention, in some embodiments thereof, relates to a system and a method for transmitting RF energy into objects, for example food objects and, more particularly, but not exclusively, to a system and a method for using radio frequency (RF) irradiation for dielectric heating and/or thawing of objects.

Commonly known dielectric heating ovens suffer from well known limitations, including uneven heating and/or slow overall heating, especially for thawing. In fact, ordinary microwave ovens, when used for thawing and even heating, normally result in foods in which parts are generally warm or even cooked before other parts are defrosted.

In order to improve wave heating technologies some systems and methods have been developed. For example, PCT/IL2007/000235 (published Aug. 30, 2007) describes a methodology for uniform heating and/or thawing of various objects, having regular or irregular shapes, including organs, foods or the like using a plurality of frequencies. This Application describes, inter alia, feeding energy into a resonant cavity of an electromagnetic (EM) heater using many frequencies that belong to a finite set of EM frequency sub-bands; the frequencies to be transmitted are selected based on sweeping a finite set of EM frequency sub-bands and transmitting a selected portion thereof at selected powers, using a plurality of EM feeds. For example, the dissipation of energy is measured for a band of frequencies, for example, the whole operation-range of the heater, and based on the measured results the finite set is selected. The Application further describes, inter alia, a band of up to 2 GHz over which the energy efficiency is measured. At times, the band may have a width between 0.5% (5/1000 [MHz]) and 25% (100/400 [MHz]) of the center frequency. The measurement may be performed before heating an object, at one or more times during heating the object, or in advance (with a sample object to define the sub-bands for additional essentially identical objects).

Other methods and systems comprising food preparation methods which overcome some of the limitations of conventional microwave ovens and are incorporated herein by reference, are PCT/IL2007/001073 (published Aug. 28, 2008), PCT/IL2007/000236 (published Aug. 30, 2008), and PCT/IL2007/000864 (published Jan. 17, 2008).

### SUMMARY OF THE INVENTION

According to some embodiments of the present invention there is provided a method of heating an object using a dielectric heating. The method comprises positioning an object in a cavity of a dielectric heating oven, allowing a user to allocate an amount of energy to dissipate in the object during a temperature elevation of the object, and elevating the temperature of the object by using the dielectric heating oven according to the amount of energy.

Optionally, the method further comprises receiving at least one property of the object, the amount of energy being calibrated according to the at least one property.

Optionally, the receiving comprises automatically measuring the at least one property.

Optionally, the method further comprises generating a dielectric heating pattern for the allocated amount of energy, the elevating comprising elevating the temperature of the object by using the dielectric heating oven according to the dielectric heating pattern.

Optionally, the dielectric heating pattern is adjusted to maintain at least one of a flavor, a dielectric coefficient, a moisture level and a texture of the object.

Optionally, the method further comprises adjusting the dielectric heating pattern by measuring at least one property of the object during the elevating.

Optionally, at least one property comprises a member from a group consisting of: a composition of the object, a ripeness level of the object, a presence of bone in the object, a presence of material for covering the object, a presence of a bag for wrapping the object, a base temperature of food object and a volume of the food object.

Optionally, the elevating comprises elevating the temperature of the object to a predefined temperature for disinfecting the object from a member of a group consisting of at least one microorganism, at least one toxin, at least one fungus, and at least one protozoa.

Optionally, the allowing comprises setting at least one heating limitation for heating the object, the elevating being performed according to the heating limitation.

Optionally, the allowing comprising allowing the user to indicate a cost and determining the amount of energy according to the cost.

Optionally, the method further comprises billing a user according to the amount of energy.

Optionally, the elevating comprises determining a uniformity level of the temperature according to the amount of energy and performing the elevating accordingly.

Optionally, the allowing comprises presenting a heating recommendation generated according to the amount of energy.

According to some embodiments of the present invention there is provided an article of manufacture comprising a seared raw meat slice. The seared raw meat slice is configured to turn a texture of at least one of medium cooking degree and well done cooking degree when maintained at a temperature of less than 60° C. for less than 30 minutes.

Optionally, the seared raw meat slice loses less than 15 percent of its weight after being maintained at the temperature.

Optionally, the seared raw meat slice comprises a member from a group consisting of a beef portion, a pork portion, a mutton portion or a lamb portion, a poultry portion, a shellfish portion, and a fish portion.

More optionally, the article further comprises a container for sealing the seared raw meat slice.

More optionally, the container is a vacuum pack.

According to some embodiments of the present invention there is provided an apparatus of heating an object using a dielectric heating. The apparatus comprises a cavity configured for containing an object, a man/machine interface (MMI) for allowing a user to allocate an amount of energy to dissipate in the object during a temperature elevation of the object, and a dielectric heating element for elevating the temperature of the object according to the amount of energy.

Optionally, the apparatus further comprises at least one field adjusting element (FAE) positioned within the cavity so as to affect the dissipation and a controller for changing at least one property of the at least one FAE according to the amount of energy.

Optionally, the apparatus further comprises a controller for controlling the dielectric heating element according to an energy budget, the controller being configured for updating the energy budget according to the amount of energy.

More optionally, the MMI is configured for allowing the user to amend the energy budget.

Optionally, the apparatus further comprises a computing unit for calculating a suggested amount of energy for heating the object, the MMI is configured for presenting the suggested amount of energy to the user.

More optionally, the apparatus further comprises at least one sensor for detecting at least one property of the object, the computing unit receiving the at least one property and performing the calculating accordingly.

According to some embodiments of the present invention there is provided an article of manufacture. The article comprises a package and a seared slice of raw meat sealed in the package. Optionally, the seared slice is frozen. Optionally, the seared slice is chilled. Optionally, the package is a vacuum package.

Optionally, the seared slice having a width of at least 5 centimeters.

According to some embodiments of the present invention there is provided a method of heating an object using a dielectric heating. The method comprises tagging an object with a plurality of machine readable tags each defining a cooking instructions set, designating at least one of the cooking instructions sets by deactivating a first group of the plurality of machine readable tags, automatically reading the at least one designated cooking instructions set from a second group of the plurality of machine readable tags, and elevating the temperature of the object by using the dielectric heating oven according to the designated cooking instructions. Each member of the second group is not a member of the first group.

Optionally, the plurality of machine readable tags comprises a plurality of printed labels, the tagging comprises attaching the plurality of machine readable tags to the object and the deactivating comprises removing the first group from the object. Unless otherwise defined, all technical and/or scientific terms used herein have the same meaning as commonly understood by one of ordinary skill in the art to which the invention pertains: Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, for example a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device for example a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary dielectric heating oven which is used in embodiments of the present invention;

FIG. 2 is a flowchart of a method for heating an object, for example a food item according to a predefined amount of energy, according to some embodiments of the present invention; and

FIG. 3 is a table of a plurality of exemplary food objects having different properties and respective required energy for elevating the temperature thereof to a final condition.

### DESCRIPTION OF SPECIFIC EMBODIMENTS OF THE INVENTION

The present invention, in some embodiments thereof, relates to a system and a method for transmitting RF energy into objects, for example food objects, more particularly, but not exclusively, to a system and a method for using radio frequency (RF) irradiation for dielectric heating and/or thawing of objects.

According to some embodiments of the present invention there is provided a dielectric heating oven and a method of heating an object, for example a food object, according to an allocated amount of energy. In such an embodiment, the temperature of an object may be elevated in a heating pattern that is determined according to the amount of energy and/or budget the user has allocated. For example, the user may allocate a number of kilojoules and/or money for a heating of a food portion.

Optionally, the heating process may be adjusted according to one or more properties of the object, for example volume, weight, and/or composition. The adjusting may be performed before and/or during the heating process.

According to some embodiments of the present invention, there is provided an article of manufacture that includes a raw meat slice that is seared and wrapped and optionally frozen or chilled. This seared raw meat may be packaged, shipped, stored and/or cooked in a sealed package (e.g. an RF transparent box or vacuum bag). The minimal dimension of at least a portion of the slice in any direction is at least 3 centimeters, at least 5 centimeters, or even at least 7 centimeters. When cooked, the seared meat slice receives a texture of a rare, medium-rare, medium, medium-well or a well done cooking degree by raising the minimal temperature from between 20° C. and 4° C. to at least 45° C. degrees within less than 10 minutes. At time the temperature reached is between 52-80° C., and at times it is about 60-68° C. In some such an embodiment, the moisture of the slice of meat remains high relatively to conventionally prepared slices of similar dimensions after the cooking process is completed.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

For clarity, as used herein a dielectric heating oven means an industrial or home appliance that uses radio frequency (RF) radiation for thawing, heating, proofing, heating and/or causing any change in the temperature and/or texture to a food item.

For example, the dielectric heating oven may be defined as described in one or more of the documents listed in Table 1 below, all of which are incorporated herein by reference:

TABLE 1

| Title | Country | Serial number | hereinafter |
|---|---|---|---|
| Electromagnetic heating | PCT | IL2007/000235 | '235 |
| Electromagnetic heating | PCT | IL2007/000236 | '236 |
| Food preparation | PCT | IL2007/000864 | '864 |
| Drying apparatus and | PCT | IL2008/000231 | '231 |
| methods and accessories | | | |
| for use therewith | | | |
| RF controlled freezing | PCT | IL2007/001073 | '073 |
| A method and a system for | USA | 61/064,201 | '201 |
| a modular device | | | |
| Dynamic impedance | USA | 12/230,431 | '431 |
| matching in RF resonator | | | |
| cavity | | | |
| Electromagnetic heating | USA | 12/153,592 | '592 |
| Device and method for | USA | Provisional | |
| thawing using RF energy | | application filed | |
| | | 10 Nov. 2008 | |
| A method and a system | PCT | IL2009/000199 | '199 |
| for a modular device | | | |

Optionally, the dielectric heating oven is configured according to one or more of the following:
1) An apparatus that allows for RF heating an object such that the temperature of the object is uniform within 50° C. (optionally, to within 10, 6, 4 or 2° C.) when heating is completed, even if the object has an irregular shape and/or composition. Exemplary embodiments provide this uniformity mainly by directly RF heating the object such that over 50% of the heating is by direct RF heating and not by conduction from other portions of the device. In some embodiments of the invention, such direct RF heating can reach 70, 80, or 90 or more percent.
2) An apparatus to gain knowledge of a heating process before and/or also one or more times during, heating (for example, several times a second) using a measurement of the efficiency of absorption of energy in the object being heated as function of frequency.
3) An apparatus for controlling one or more characteristics of the heating process, for example the amount of power absorbed in the heated object, based on the measurement of energy absorption efficiency (for example, by transmitting power to compensate for the variations of energy absorption and/or variations of energy transmission). This may be done by adjusting, for example, input power at each transmitted frequency and/or choosing frequencies to be transmitted and/or adjusting (for example, moving or rotating) one or more field adjusting elements and/or moving the heated object and/or changing antenna characteristics. This may be done before operation, and/or at times also one or more times during operation (for example, several times a second), based on measurements of energy absorption during heating or during a short hiatus in the heating.
4) An apparatus which during operation the transmitted frequencies and/or power from one or more feeds are varied in a controlled manner to get a desired heating pattern (for example, by more than 1, 2 or 5 MHz). This variation may occur several times during operation (for example, several times a second). In an embodiment of the invention, the desired pattern is a uniform heating pattern.
5) Apparatus for controlling heating based on reading of dielectric characteristics of the heated object. Reading may be obtained one or more times during heating (for example, several times a second). For example end of thawing or boiling process, when a phase change is sensed. This can implement a cessation of heating.
6) An electromagnetic heater including multiple inputs in which the frequencies of the inputs are different by more than 5, 10 or 25 MHz.
7) An electromagnetic heater including multiple inputs in which the frequencies of at least one of the inputs changes dynamically during heating such that the frequencies at the inputs vary by 5 MHz or more.
8) An apparatus that utilizes a wideband and high efficiency (above 40%) solid state microwave amplifier to feed energy into the cavity and optionally utilize waste heat generated by the generator to heat the air in the cavity.
9) An apparatus that utilizes wasted heat generated by the RF energy generator to heat a medium, for example air in the cavity, or water, as in a water heater.
10) An apparatus for causing a resonance structure and/or designed pattern, inside a resonator to radiate by (selectively or generally) irradiating said resonance structure and/or designed pattern thus using it as a radiation source (i.e. creating a passive source) and an apparatus comprising same.
11) Apparatus for using RF reflecting object, for example metals, for concentration of energy in close environment of these objects, inside a resonator, for example within the heated object or in the close environment of the heated object.
12) A high-efficiency (at least 50%, at times above 70% or even 80%) RF heater. The efficiency is defined as power absorbed in the object versus power at the output of the power source. This allows the possibility of a heater that operates using a solar energy source.
13) An RF heater weighing less than 15 Kg, or even less than 10 Kg. In accordance with some embodiments of the invention the use of a high efficiency solid state amplifier rather than a microwave tube or magnetron allows for using a low weight DC power source instead of the heavy duty transformer. This weight savings is additional to the replacement of a heavy magnetron with a light solid state amplifier. Furthermore, the high efficiency eliminates the need for a heat sink, for example, by using the resonator as a heat sink. In some embodiments of the invention, the requirement for a heat sink is obviated or partly reduced by feeding the waste heat from the amplifier back into the microwave cavity.
14) An apparatus for RF heating including means for chamber environment control (for example, introduction and/or removal of humidity, cooling and/or warming etc.). For example, in the case of an egg being boiled, heating would reduce the temperature gradient (and therefore stress) across the egg shell, thus reducing the chances of cracking and bursting. Optionally, the air temperature in the chamber may be varied with time, depending on the present temperature of the object and objectives for example causing condensation that closes the object being heated (for example meat).
15) An apparatus in which the power absorbed by the object being heated can be calculated based on knowledge of power input and efficiency of power transfer to the object being heated. This allows for the calculation of a current temperature and/or a turn off-time based on actual heating rather than some estimated heating time as presently used with microwave cookers.

For clarity, the implementation of the apparatuses 1-15 may be as described in one or more of the patent applications listed in Table 1.

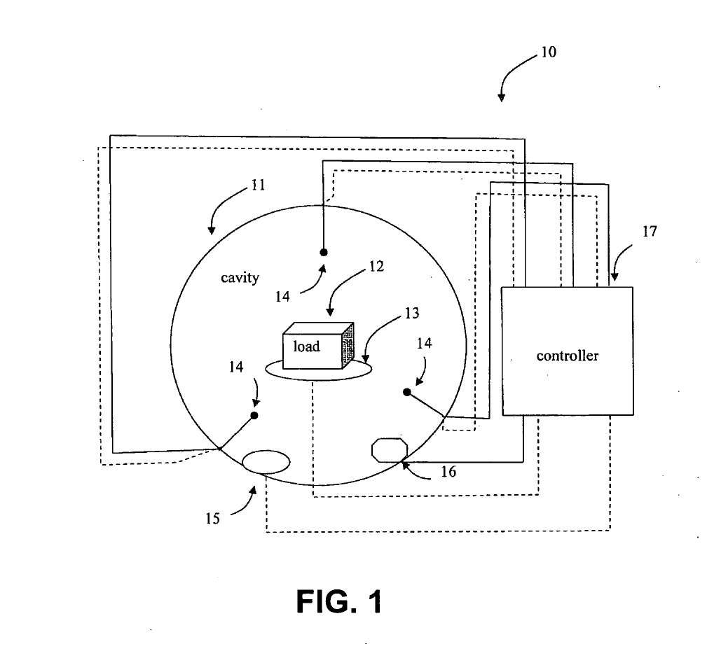

Reference is now made to FIG. 1, which is a schematic illustration of an exemplary dielectric heating oven 10 according to an embodiment of the present invention. In an exemplary embodiment of the invention, the device is constructed and operated as described in one or more of the patent applications listed in Table 1, with one or more of the changes detailed below. In particular, in an exemplary embodiment of the invention, the dielectric heating oven is adapted to substantially uniformly heating food objects, for example pieces of meat and/or dough according to predefined dielectric energy dissipation patterns or heating patterns, for example as described below. As used herein, a dielectric heating pattern means one or more profiles that define the frequency(ies), the power(s), the energy at each of a plurality of frequencies and/or the period of emitting RF radiation for dielectric heating of the object that is placed in the cavity 11 of the oven 10.

Additionally or alternatively, the dielectric heating oven is configured such that power transmission is avoided to high absorption portions (for example, water), so that the low absorption portions remain substantially unheated (or substantially heat less) during a dielectric heating process, see U.S. Provisional Patent Application No. 61/193,248, filed on Nov. 10, 2008, (hereinafter “the '248 patent application”), which is incorporated herein by reference. Additionally or alternatively, the dielectric heating oven is configured baking bread from frozen and/or thawed pieces of dough.

Dielectric heating oven 10, as shown, comprises a cavity 11. Cavity 11 as shown is a cylindrical cavity made of a conductor, for example a metal for example aluminum. However, it should be understood that the general methodology of the invention is not limited to any particular resonator cavity shape. Cavity 11, or any other cavity made of a conductor, operates as a resonator for electromagnetic waves having frequencies that are above a cutoff frequency, for example 500 MHz or higher, which may depend, among other things, on the geometry and size of the cavity. Methods of determining a cutoff frequency based on geometry and size are well known in the art, and may be used.

A load 12 is placed within the cavity, optionally on a supporting member 13, for example a conventional microwave oven plate. In an exemplary embodiment of the invention, cavity 11 comprises one or more RF energy feeds 14 (for example, antennas) which may be used for transmitting RF energy into the cavity. The energy is transmitted using any method and means known in that art, including, for example, use of a solid state amplifier. One or more, and at times all, of the feeds 14 can also be used one or more times during the thawing process for obtaining the spectral information of the cavity within a given band of RF frequencies to determine the spectral information of the cavity (for example, dissipation of energy into the cavity) as a function of frequency in the working band. This information is collected and processed by controller 17, as will be detailed below.

In an exemplary embodiment of the invention, cavity 11 also comprises one or more sensors 15. These sensors may provide additional information to controller 17, including, for example, temperature (for example, by one or more IR sensors, optic fibers or electrical sensors), humidity, weight, etc. Another option is use of one or more internal sensors embedded in or attached to the load, for example an optic fiber or a TTT as disclosed in the '236 patent application.

Alternatively or additionally, cavity 11 may comprise one or more field adjusting elements (FAE) 16. An FAE is any element within the cavity that may affect its spectral information or the spectral information derivable therefrom. Accordingly, an FAE 16 may be for example, any object within cavity 11, including one or more of metal components within the cavity, feed 14, supporting member 13 and even load 12. The position, orientation, shape and/or temperature of FAE 16 are optionally controlled by controller 17. In some embodiments of the invention, controller 17 is configured to perform several consecutive sweeps. Each sweep is performed with a different FAE property (for example, changing the position or orientation of one or more FAE) such that different spectral information may be deduced. Controller 17 may then select the FAE property based on the obtained spectral information. Such sweeps may be performed before transmitting RF energy into the cavity, and the sweep may be performed several times during the operation of dielectric heating oven 10 in order to adjust the transmitted powers and frequencies (and at times also the FAE property) to changes that occur in the cavity during operation.

In an exemplary embodiment of the invention, the FAEs are controlled and/or load rotated or moved, so that a most useful spectral information is acquired for selective irradiation and/or for setting of radiation parameters, for example as described below. Optionally or alternatively, the load and/or FAEs are periodically manipulated and/or based on a quality or other property of acquired spectral information. The acquired spectral information may be used for adjusting the heating process. Optionally, the spectral information allows the adjustment of the heating process according to preferences of the user. For example, if the uniformity of the heating is more preferable than the velocity of the heating, a higher average dissipation rate at more frequencies is selected. If the user selects thawing, a higher variance of dissipation into the load at different frequencies is selected.

An exemplary schematic transfer of information to the controller is depicted by dotted lines. Plain lines depict the control exerted by controller 17, for example the power and frequencies to be transmitted by a feed 14 and/or dictating the property of FAE 16. The information/control may be transmitted by any means known in the art, including wired and wireless communication.

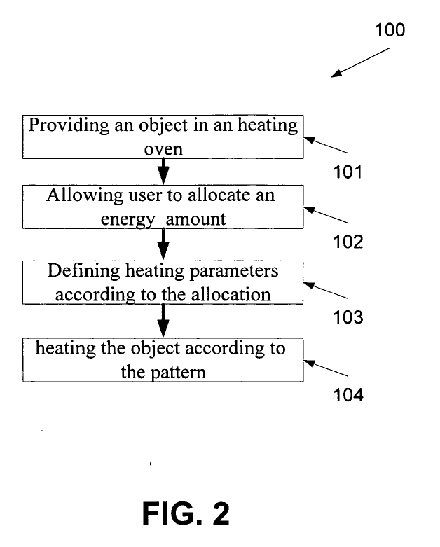

Reference is now made to FIG. 2, which is a flowchart of a method 100 for heating an object, for example a food item according to a predefined amount of energy, according to some embodiments of the present invention. The heating is optionally performed using a dielectric heating oven, for example the dielectric heating oven in FIG. 1 and/or a dielectric heating oven as described above and/or in '864, '235, '073, '248 and/or '236 patent applications.

The method 100 allows a user to define the amount of energy that is consumed by a dielectric heating of an object. In such a manner, the user may allocate the amount of energy which is consumed or dissipated during the implementation of one or more dielectric heating patterns. It should be noted that the RF generation energy, which is consumed for generating the RF radiation, may be equal to or larger than the transmitted energy, which is actually transmitted to the object. Moreover, the transmitted energy is equal to or larger than the dissipated energy which is absorbed by the object and cooks, thaws, and/or otherwise affects the object. Optionally, the user may define any of the RF generation energy, the transmitted energy, and/or the transmitted energy. In such an embodiment, conversion equations may be used for allocating the amount of energy that is consumed or dissipated during the implementation of one or more dielectric heating patterns.

This ability allows the user to plan and/or to change dynamically the energy expenses pertaining to the heating of an object. For example, the user may determine in advance a sum of joules or kilojoules (kis) that are to be allocated for heating a certain amount of food. In another embodiment, the user determines in advance a cost, for example energy cost, maintenance cost and/or a combination thereof, for example as defined below. The cost may be translated by the controller or a calculation module to a sum of energy. This sum may define the dielectric heating pattern according to which the object is heated.

First, as shown at 101, an object, for example a food item, is positioned in a cavity 11 of a dielectric heating oven 10. The object may be a food portion, a meal course, a frozen tissue, a heat absorbing element, a meal course served by a catering service and/or a restaurant, a material to be dried, for example a textile element, and the like. The positioning may be manual, for example by a user (for example, at home) and/or automatic, for example for heating an object in a production line process. Optionally, the dielectric heating oven 10 may operate regardless of the exact positioning of the object in the cavity 11.

Now, as shown at 102, the user allocates the amount of energy that is about to be consumed during the heating of the object that is or is to be positioned in cavity 11 of the dielectric heating oven 10. Optionally, the dielectric heating oven 10 comprises a man-machine interface (MMI), such as a keypad, a keyboard, a touch screen and a set of buttons, for allowing the user to define the amount of energy to be consumed during one or more dielectric heating actions which are designated for heating an object, such as the food item. Optionally, the MMI is a separate unit, for example a remote control, which communicates with the dielectric heating oven 10 via a remote communication channel, for example a wireless communication channel.

Alternatively or additionally, the MMI allows the user to define a heating process and presents the amount of energy to be consumed during user defined heating process. In such an embodiment, the user may or may not approve the user defined heating process. Optionally, the MMI allows the user to define the heating process purpose, for example cooking, thawing and/or maintaining a constant or a substantially constant temperature. If cooking is selected, the amount of energy may be calculated according to user inputs and/or automatic measurements of the characteristics of the object, for example according to one or more of the following:
1. The type of object. For example if the object is a food object, for example, meat, fish, poultry, potatoes, vegetables, and the like. The food type from a list that is presented to the user by the MMI.
2. A weight of the object, for example according to scales which are built-in the device and/or according to manual input or selection of the user. It should be noted that if weight is used for determining the heating process, the weight of a container has to be taken into account. It should be noted that in some embodiments, allocation may be performed according to the mass, regardless of the ratio between the surface and the volume and or the shape. Optionally, the object is positioned in a container having a known weight. The weighed container may be a container that is weighed by built-in scales in an independent interval and/or a container having a known weight that has been provided in advance, either by using the MMI and/or as part of the calibration of the dielectric oven. Optionally, the pre-weighed container is marked with a tag representing its weight, such as a barcode. In such an embodiment, the dielectric oven comprises a barcode reader for determining the weight of the container. Optionally, the pre-weighed container is a detachable plate, tray, and/or concavity which is sized and shaped to the fit into the cavity of the dielectric oven, for example, having a member that is fitting in a groove or slot.
3. The degree of cooking.
4. A target temperature.
5. A heating velocity, for example as a maximal heating time.
6. A homogeny level, for example by defining a heat dissipation balance.
7. A pre-cooking temperature. This characteristic may be detected automatically by a temperature sensor or manually for example by a selection among predetermined settings, such as “frozen,” “fridge,” “room temperature,” “hot,” “cool,” “cold,” etc. In some embodiments, the selection may involve choosing an exact temperature.
8. The properties of at least one of the main components of the object. For example, in a casserole recipe one might input the weight and type of the main ingredients, for example one pound of meat and/or one half pound of potatoes, but not secondary ingredients, such as a teaspoon of a spice or the like.

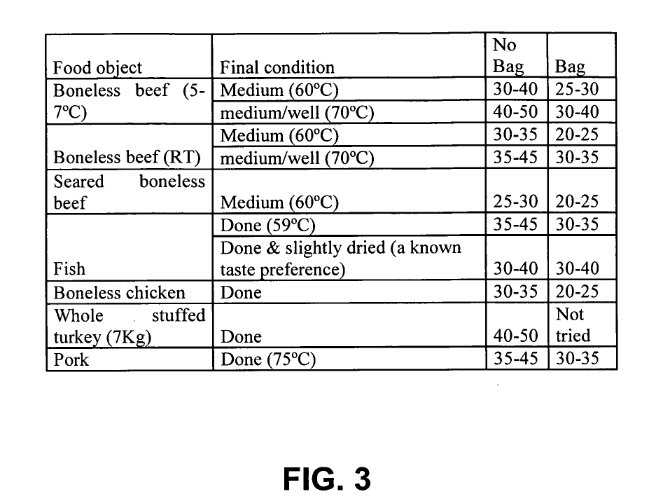

Alternatively or additionally, the MMI allows the user to define a heating process by selecting the amount of energy from a list or a table, such as the table depicted in FIG. 3. In such an embodiment, the user may define the degree of cooking, the final temperature, the -cooking temperature, and/or the homogeny level.

Alternatively or additionally, the user may define a budget and/or a cost for a dielectric heating process. For example, the user may use the MMI to provide the budget by indicating a total amount, such as 0.5$, 1$, 2$, 5$, 10$ and the like. Optionally, the provided budget is converted to an amount of allocated energy and used, as outlined above and described below for defining the dielectric heating process. Optionally, a cost-energy consumption conversion ratio is stored by the dielectric oven for allowing the aforementioned conversion. Optionally, the cost-energy consumption conversion ratio is updated manually, for example by the user, and/or automatically, for example by an internet connection and/or any other communication connection. Optionally, the MMI presents the cost for the approval of the user.

Alternatively or additionally, the user may define a budget and/or a cost for a dielectric heating process and the uniformity level of the temperature of the heated object is determined accordingly. Uniform heating requires more energy and therefore the amount of allocated energy affects the uniformity of the final temperature of the heated object. Optionally, the user defines a uniformity level and the amount of energy that is required for acquiring such a uniformity level is allocated and/or presented as a heating recommendation for her approval.

Alternatively or additionally, the MMI presents a heating recommendation to the user. In such an embodiment, the heating recommendation may be based on the outputs of the sensors which are designed to probe the objects in the cavity 11 of the oven, for example a composition analyzer, a weighting machine, and/or a volume sensor which are integrated and/or otherwise connected to the dielectric heating oven, as described below. The heating recommendation may be based on the inputs of the user. The recommendation may specify the heating cost and/or the amount of energy that is to be consumed by the recommended heating. Optionally, the MMI presents a number of recommendations and/or score for possible heating patterns. Optionally, the MMI presents a recommendation that allows the user to save energy. In use, the user may define a requested uniformity level. In some embodiments, the heating recommendation may be to reduce the requested uniformity level to a level which is less uniform and/or that reduces the amount of required energy and/or cooking time. Other heating recommendations may include a recommendation to reduce the final temperature while increasing uniformity or reducing energy consumption. Alternatively or additionally, the recommendation may be to heat a number of objects together. Optionally, the MMI allows the user to define a number of prospective objects for heating, related heating definitions, such as final temperature and uniformity, and optionally a related time of service. In such an embodiment, the recommendation may include a heating order and/or a suggestion of which objects should be heated together, etc.

Alternatively or additionally, the heating oven 10 includes a communication interface, such as a wireless interface, for example a wireless Bluetooth® interface, a wireless local area network (LAN) interface, a wideband code division multiple access (WCDMA) cellular link, and/or a satellite link or a wired interface, such as a LAN interface. Optionally, the communication interface is used for forwarding energy consumption data to a billing server. In such a manner, the user may be charged according to the actual energy that is used during the heating process.

Alternatively or additionally, the user may define other stopping criteria, such as heating time, heating target temperature, and the like. In some embodiments, the heating process may be stopped either when the stopping criteria is fulfilled or when the amount of energy spent during the heating process reaches a maximum energy consumption threshold, whichever comes first. Optionally, the heating may be stopped when one of the stopping criteria is reached only if a minimum energy consumption threshold has also been reached.

Optionally, the heating process is limited according to one or more constraints that assure the RF radiation dissipation does not exceed a certain limit. For example, the maximal dissipated energy for a served dish may be limited to a number between 50-60 Kj/100 gr of food to be heated.

In some embodiments of the present invention, the user determines an energy scale that defines the energy that the user is ready to dissipate per unit, such as a weight unit and/or a mass unit. For example, the user may determine an energy scale that defines how many joules the device may use for heating each 100 grams (gr).

As shown at 103, parameters of a dielectric heating pattern are defined according to the allocated amount of energy. The dielectric heating pattern may include one or more heating sessions during which the object is irradiated with RF radiation for elevating its temperature and/or changing its state of aggregation and/or thawing some or the entire object. The parameters changed may include one or more of the final temperatures, the size of the load, the degree of uniformity of energy dissipation in the load, the degree of uniformity of desired temperature of the load, etc. Optionally, the RF radiation pattern that is used during the dielectric heating of the object is determined in a calibration process, for example as described in the '235 patent application. During the calibration, a set of one or more variable elements is calculated for heating the object that is placed in the cavity 11 of the dielectric oven in a heating pattern that is defined according to the allocated amount of energy. Optionally, the set of one or more variable elements, referred to herein as dielectric heating parameters, is calculated according to the amount of energy defined in 101.

As described in the '235 patent application, the dielectric heating parameters may include a finite set of sub-bands of frequencies of each one of the voltage-controlled oscillators (VCOs) of the dielectric oven, a power output of amplifiers in power feeds to the cavity 11 at one or more frequencies chosen to be transmitted, the pattern of providing energy at the various frequencies, for example a sweeping pattern, a frequency variation pattern, a provision of a pulsed signal embodying a desired frequency and/or power characteristics, a positioning of matching elements, a maneuvering pattern of the object, and/or any variable that affects a characteristic of the heating process, for example the uniformity and/or the efficiency of consumed energy. An exemplary calibration is described in the '235 patent application.

Optionally, the calibration includes identifying dielectric heating parameters that increase, optionally maximize, the utilization of energy during the dielectric heating process. Optionally, the calibration includes determining one or more frequencies of the RF radiation in order to increase, optionally maximize, the utilization of energy during the dielectric heating process example as described in the 235' patent application. In such an embodiment, the dielectric heating oven 10 may radiate the object with RF radiation in a range of frequencies between a minimum and a maximum frequency for the channel, for example as described in the 235' patent application. In some embodiments of the present invention, the frequency is swept, optionally while adjusting the power, for example according to the set energy amount. The term swept should be understood to include serial transmission of individual non-contiguous frequencies, and transmission of synthesized pulses having the desired frequency/power spectral content. Optionally, the minimum and maximum frequencies are 800 MHz and 1000 MHz. Other ranges, such as between 860 MHz and 1040 MHz may be used. It is believed that substantially any range between 300 MHz and 1000 MHz or even up to 3 GHz is useful depending on the heating task being performed and/or the allocated energy which have been defined by the user. The sweep may be performed in one or more non-contiguous bands. Optionally, the measuring of the dissipations and/or reflections allows measuring the amount of RF radiation that is absorbed in each one of the frequencies. Such measurements allow calculating the maximum net power efficiency for each RF radiation in the swept frequencies, for example as described in the 235' patent application.

Optionally, the calibration includes calibrating additional dielectric heating parameters that affect the heating of the object and/or the energy that is required for performing the heating, for example as described in the 235' patent application.

Optionally, the dielectric heating pattern is defined according to one or more minimum heating requirements that define a minimum level of heating for disinfecting the object, which may be a food object, from microorganisms, toxins, fungi, and/or protozoa.

In some embodiments of the present invention, the parameters of the heating pattern are determined according to the allocated energy and/or a selected heating protocol (e.g. defrosting/desired uniformity or lack thereof, etc.) and one or more properties of the heated object. Optionally, the one or more properties, which may include, weight, volume, composition, base temperature, and thickness, are identified automatically, for example using a composition analyzer, a weighting machine, and/or a volume sensor which are integrated and/or otherwise connected to the dielectric heating oven, for example as described below. Optionally, some or all of the aforementioned one or more properties are provided manually, for example using the aforementioned MMI or through machine readable insignia (for example, a barcode or RF tag attached to the object to be heated or its container).

Optionally, the dielectric oven integrates a volume sensor, such as a float-type depth detector, an optical volume sensor, and a pressure transducer (PT), for measuring the volume of the object that is placed in the cavity 11 of the dielectric heating oven 10. In such an embodiment, the heating process may be regulated according to changes in the volume of the object.

Optionally, the dielectric oven integrates a weighing machine, optionally digital, for measuring the weight of the object that is placed in the cavity 11 of the dielectric heating oven 10. In such an embodiment, the amount of energy may be calculated by automatically multiplying the weight that is calculated by the weighing machine with the defined energy scale. For example, if the object is a ball of rice that weights 800 gr and the defined energy scale is 2 Kj/100 gr, the allocated amount of energy is 16 Kj. Alternatively, the allocated energy is determined by the user. For example, the user may use the MMI for defining maximum and/or minimum energy consumption thresholds.

Optionally, the heating pattern 103 may be calculated according to units of energy per unit of weight, referred to herein as energy consumption units, for example, according to Kj per 100 gr units, referred to herein as Kj/100 gr. Optionally, the weight of the food object is determined according to the weighing machine's outputs.

In some embodiments of the present invention, the dielectric oven integrates a composition analyzer, such as a spectrometer, optionally digital, for detecting the composition of the object that is placed in the cavity II of the dielectric heating oven 10. In such an embodiment, the dielectric heating pattern and/or target temperature may be selected according to spectral information that is indicative of the type or composition of the object. For example, the heating pattern and/or target temperature may be adjusted to maintain a flavor, a dielectric coefficient, a moisture level and/or a texture of a food having the respective spectral information

In some embodiments of the present invention, the dielectric oven integrates a temperature sensor for measuring the temperature of the heated object. Such a temperature sensor may provide the base temperature of the heated object. Optionally, the temperature sensor comprises a sensor, for example an infrared temperature sensor, such as the OS101 Series Miniature Low-Cost Non-Contact Infrared Temperature Sensor/Transmitter from NEWPORT and an infrared temperature sensor such as the OS136 Series Miniature Low-Cost Non-Contact Infrared Temperature Sensor/Transmitter from OMEGA Engineering. The temperature sensor may be used for monitoring and/or adjusting the heating process and/or the heating pattern, for example as described below.

Optionally, the heating pattern is adjusted according to oven parameters, for example cavity size and used antennas. It should be noted that the oven parameters may be fixed and/or dynamic, for example as described in U.S. Provisional Patent Application No. 61/064,201, filed on Feb. 21, 2008, which is incorporated herein by reference.

Optionally, the heating pattern is adjusted according to the base temperature of the object, for example the temperature of the object before a heating process or heating step begins and/or according to a requested temperature that is entered by the user, for example by using the MMI. In such an embodiment, the user may provide a requested temperature or an allocated energy. The final temperature may be selected directly (for example, by inputting and/or selecting a specific temperature or a temperature range and/or indirectly (for example, by selecting a desired effect for example the level of cooking and/or a desired detectable change in the object. The base temperature may be detected using the aforementioned temperature sensor and/or provided by the user via the MMI. In such an embodiment, the computing unit of the dielectric heating oven, for example the computing unit that is connected to the aforementioned controller, calculates the feasibility of the requested temperature in the light of the allocated energy. If the allocated energy is not sufficient for elevating the temperature of the object to the requested temperature the MMI presents a notification to the user.

Optionally, the heating pattern is adjusted according type of food object, for example whether the food object includes meat and what the type of meat is. For example, if the type of meat is mutton, the energy consumption for each weight unit is set as exemplified in the column headed “no bag” in FIG. 3.

Optionally, the heating pattern is adjusted according the presence and/or absence of a bone portion. For example, if the food object comprises a certain bone portion, the amount of energy that is used for heating the food object increases a few kilojoules per gram of bone. Optionally, the increase depends on the type of the bone. For example, a chicken bone induces a smaller addition to the total amount of energy required than a beef bone and a fish bone induces a smaller addition to the total amount of energy than a chicken bone.

Optionally, the heating pattern is adjusted according to whether the food object is sealed (for example, positioned in a food sealing bag or a box or covered with wrapping) or not. Optionally, the user uses the MMI to define whether or not the food object is sealed. Wrapping the food object in a bag before the dielectric heating may reduce the energy consumption for each weight unit in 5% to 10%. FIG. 3, which is a table of a plurality of exemplary food objects having different properties, exemplifies the effect of the bag on the energy consumption. The table further exemplifies the effect of a bone on the energy consumption and the differences between different types of meat. It should be noted that the term seared in the table means that the meat was seared before RF was transmitted (for example, on a stove or conventional grill), such that the outer layer has been heated (for example, to about 80° C. or more) while the interior has been heated only up to 20° C. or 10° C. (or less).

Optionally, the heating pattern is adjusted according to the ripeness of the object. As used herein, ripeness means the age of a slice of meat, the ripeness level of a vegetable and the like. As commonly known, aged slices of meat cook faster than slices of meat that was not aged for long as the proteins and the connective tissues it contains are partly decomposed. Optionally, the MMI allows the user to select from a plurality of period ranges, for example hours, days, and weeks. Optionally, the ripeness is evaluated automatically by the aforementioned composition analyzer. It should be noted that the ripeness level is indicative of the water content in the food object. The fresher is the food object, the higher is the share of water in its composition and therefore more energy is required for the heating process.

After the dielectric heating parameters are determined, the dielectric heating commences, as shown at 104. Optionally, the heating is periodically interrupted and/or sustained for a short time, for example a period of half a second or one or more tenths of a second, for recalibrating the heating process. Optionally, the recalibrating process is similar to the aforementioned calibration process and allows adjusting the dielectric heating according to the affect of the heating on the object. For example, frozen objects may be defrosted during the dielectric heating. Thawing changes the RF radiation absorption pattern of the object than in a frozen state. The recalibrating process allows detecting the change in the RF radiation absorption pattern and adjusting the frequency of the RF transmission into the cavity.

As outlined above and described in 864', 235', 073', and 236' patent applications, dielectric heating oven 10 may be configured for radiating the object with an RF radiation that has been adjusted to heat the object substantially uniformly. Uniform heating may be performed even if the object thickness is more than 3, 4, 5, 6, 7, 8, 9, 10, 15, and 20 inches or more and/or intermediate values, for example as described in 864', 235', 073', and 236' patent applications. As used herein, heating substantially uniformly means heating 75%, 80%, 85%, and 90% or more of the object's volume, and/or intermediate values, to the same temperature or to a temperature in a range of less than 3, 2, and/or 1 degree(s).

According to some embodiments of the present invention, there is provided an article of manufacture that includes a thick slice of beef, fish, chicken or other meat, for brevity referred to herein as a meat slice. The meat slice is optionally seared and enclosed in a vacuum seal or box. Optionally, the wrapped meat slice is maintained in a refrigerated state before the cooking thereof. When a user desires to prepare the meat slice for eating by heating, dielectric heating may be used. For example, the heating process may include heating the meat to the desired cooking degree, for example rare, medium, well done, and/or any intermediate cooking level and/or a cooking degree that is defined by a desired final temperature, as known in the art. As the meat slice has been seared in advance, the temperature of the meat slice, optionally the meat slice's exterior temperature does not have to be elevated above the desired final temperature in order to achieve a texture of a meat slice that is cooked sufficiently for consumption. In such a manner, the loss of moisture of the meat slice is reduced and the humidity thereof remains relatively high after the heating process. Optionally, as the heating is in relatively low temperatures, the meat slice loses around 5% to 15% of its weight during the heating process. Conventional: up to 40%. Optionally, the color of the internal portion of the slice of meat remains relatively dark.

Optionally, the meat slice is cooked any degree of cooking that is requested by the user. For example, if the user desires a medium rare degree of cooking in which the meat slice has a firmer texture and has a warm red center; the meat slice may be heated to approximately 55° degrees without over heating any portion thereof. If the user desires a Medium degree of cooking in which the meat slice has a pink and firm texture, the meat slice may be heated to approximately 60° degrees. The meat may be maintained at the final temperature for 15 minutes, 30 minutes or more. The meat may also be chilled and/or reheated to the desired final temperature without changing its coloring.

The container and/or the meat slice may be tagged with one or more machine readable tags, for example one or more barcodes, radio frequency identification (RFID) tags and the like. Optionally, each one of the machine readable tags details different parameters of the heating protocol, for example while one of the machine readable tags details instructions for heating a meat slice to a rare cooking level, another machine readable tag details instructions for heating the meat slice to a medium rare cooking level. In use, the user designates cooking instructions by selecting one of the machine readable tags and removing all the others. In such a manner, only the selected machine readable tag is read by a respective reader to provide the cooking instructions to the device. Alternatively, the tags are additive, whereby more tags may mean a higher (or lesser) degree of cooking and the user may remove some of the tags such that the remaining amount of tags will define the cooking instruction.

It is expected that during the life of a patent maturing from this application many relevant apparatus and methods will be developed and the scope of the term heating, RF irradiation, dielectric heating, and dielectric heating oven 10 is intended to include all such new technologies a priori.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An article of manufacturing comprising a seared raw meat slice; wherein said seared raw meat slice is configured to turn a texture of at least one of medium cooking degree and well done cooking degree when maintained at a temperature of less than 60° degrees for less than 30 minutes.

2. The article of claim 1, wherein said seared raw meat slice loses less than 15 percent after being maintained at said temperature.

3. The article of claim 1, wherein said seared raw meat slice comprises a member from a group consisting of a beef portion, a pork portion, a mutton portion, lamb portion, a poultry portion, a shellfish portion, and a fish portion.

4. The article of claim 3, further comprising a container for sealing said seared raw meat slice.

5. The article of claim 3, wherein said container is a vacuum pack.

6. An article of manufacturing comprising:
a package; and
a seared slice of raw meat sealed in said package.

7. The article of claim 6, wherein said seared slice is frozen.

8. The article of claim 6, wherein said seared slice is chilled.

9. The article of claim 6, wherein said package is a vacuum package.

10. The article of claim 6, wherein said seared slice has a width of at least 5 centimeters.

11. A method of heating an object using a dielectric heating, comprising:
tagging an object with a plurality of machine readable tags each defining a cooking instructions set;
designating at least one of said cooking instructions sets by deactivating a first group of said plurality of machine readable tags;
automatically reading said at least one designated cooking instructions set from a second group of said plurality of machine readable tags; and
elevating the temperature of said object by using said dielectric heating oven according to said designated cooking instructions;
wherein each member of said second group is not a member of said first group.

12. The method of claim 11, wherein said plurality of machine readable tags comprises a plurality of printed labels, said tagging comprises attaching said plurality of machine readable tags to said object and said deactivating comprises removing said first group from said object.
